(19) United States
(12) Patent Application Publication
(10) Pub. No.: US 2023/0391141 A1
(43) Pub. Date: Dec. 7, 2023

(54) Pneumatic Tire for Aircraft

(71) Applicant: BRIDGESTONE CORPORATION, Chuo-ku, Tokyo (JP)

(72) Inventors: Eiji ICHIHARA, Chuo-ku, Tokyo (JP); Naoto KOCHI, Chuo-ku, Tokyo (JP); Juntarou TAMURA, Chuo-ku, Tokyo (JP)

(73) Assignee: BRIDGESTONE CORPORATION, Chuo-ku, Tokyo (JP)

(21) Appl. No.: 18/250,749

(22) PCT Filed: Apr. 30, 2021
(86) PCT No.: PCT/JP2021/017280

§ 371 Date: Apr. 27, 2023

(30) Foreign Application Priority Data
Nov. 19, 2020 (JP) 2020-192349

(51) Int. Cl. B60C 9/28; B60C 9/22

(52) U.S. Cl. CPC B60C 9/28; B60C 9/22

(57) ABSTRACT

A pneumatic tire for aircraft according to this disclosure satisfies the following inequality in the reference state, 0≤δ35/Rc≤0.004 and 0.015≤δ90/Rc≤0.025.

### TECHNICAL FIELD

This disclosure relates to a pneumatic tire for aircraft.

### BACKGROUND

Conventionally, the pneumatic tires for aircraft have been

proposed: which have a pair of bead cores, a radial carcass comprising one or more carcass plies extending toroidally between the bead cores, and a belt layer as a tread reinforcement member on the radial outer side of the radial carcass in the tread portion; the above belt layer consists of a spiral belt layer made of ribbon-like organic fibers wound in an abbreviated circumferential direction, 5 degrees or less to the tire equatorial plane, and a zigzag belt layer made of ribbon-like organic fibers wound at an angle of 2 to 45 degrees to the tire equatorial plane and folded at both ends of the belt; and the shape of the outer surface of the tread has a predetermined step-down amount δ at the intermediate land portion (PTL 1).

Citation List

Patent Literature

PTL 1: 2012-153310

### SUMMARY

### Technical Problem

In recent years, increased environmental awareness has led to strong demand for longer tire life also in pneumatic tires for aircraft. Improving the wear resistance performance of the tire is effective in extending tire life. Here, it is known that the wear on the pneumatic tires for aircraft occurs mainly in the following two modes: One is the wear that occurs when an aircraft moves through an airport, so-called “taxi wear”, and the other is the wear caused by slippage when stationary tires contact the asphalt at high speed at the moment the aircraft lands, so-called “touchdown wear”.

The art described in PTL 1 is effective in improving the above taxi wear. However, when the shape of the outer surface of the tread as described in PTL 1 is applied, the ground contact width under extreme loads at the moment the aircraft lands become smaller. As a result, wear in the center of the tire progressed quickly, and in some cases, performance was not sufficient with respect to touchdown wear.

It is therefore an object of this disclosure to provide a pneumatic tire for aircraft that can suppress the wear that occurs when moving through airports, while also suppressing the wear that occurs at extremely low loads at the moment the aircraft lands.

### Solution to Problem

The following is the abstract structure of this disclosure. (1) A pneumatic tire for aircraft comprising:

a pair of bead portions; a carcass comprising one or more carcass plies spanning the pair of bead portions in a toroidal shape; and a belt comprising one or more belt layers disposed radially outwardly of the crown portion of the carcass; wherein

in a reference state, in which the pneumatic tire for aircraft is mounted on an applicable rim, filled to prescribed internal pressure, deflated to 50 kPa after that, and with no load,

Rc is the radius at the outer surface of the tire at the tire equatorial plane, and Wb is the distance in the tire width direction from the tire equatorial plane to the edge of the widest belt layer that has the greatest width in the tire width direction,

the diameter difference between the outer surface of the tire at the tire equatorial plane and the outer surface of the tire at a position 35% of the distance Wb outward from the tire equatorial plane in the tire width direction is δ35,

the diameter difference between the outer surface of the tire at the tire equatorial plane and the outer surface of the tire at a position 90% of the distance Wb outward from the tire equatorial plane in the tire width direction is δ90, and the following inequalities are satisfied.

0≤δ35/Rc≤0.004 and 0.015≤δ90/Rc≤0.025

As used herein, “applicable rim” refers to the standard rim (Design Rim) in the applicable size as described or as may be described in the future in the latest edition of the AIRCRAFT YEAR BOOK or the latest edition of the EDI (Engineering Design Information for Aircraft Tires) published by TRA (The Tire and Rim Association, Inc.) in the United States (the 2017 edition is used for numerical descriptions herein). For sizes not listed in the above standards, “applicable rim” shall mean the rim applicable to the tire.

In addition, “prescribed internal pressure” means the air pressure, i.e., maximum air pressure, corresponding to the maximum load capacity of a single wheel in the applicable size and ply rating, as described in the above standard. For sizes not listed in the above standards, “prescribed internal pressure” shall mean the air pressure, i.e., maximum air pressure, corresponding to the maximum load capacity prescribed for each vehicle in which the tire is mounted.

In the case where the tread section has grooves, the above outer surface of the tire shall mean the hypothetical line assuming there are no grooves.

The elastic modulus of the belt cord herein refers to the elastic modulus of a single cord (cN/dtex) calculated from the slope “s-s curve” when a single cord is elongated by 1.5% in accordance with the standard number JIS L 1017:2002, “Test Method for Chemical Fiber Tire Cords”.

### Advantageous Effect

This disclosure can provide a pneumatic tire for aircraft that can suppress the wear that occurs when moving through airports, while also suppressing the wear that occurs at extremely low loads at the moment the aircraft lands.

### BRIEF DESCRIPTION OF THE DRAWINGS

In the accompanying drawings:

FIG. 1 illustrates a cross-sectional view in the tire width direction of a pneumatic tire for aircraft according to one embodiment of this disclosure;

FIG. 2 illustrates an enlarged view of the main part of FIG. 1;

FIG. 3 illustrates the spiral belt layer; and

FIG. 4 illustrates the zigzag belt layer.

### DETAILED DESCRIPTION

The following is a detailed illustrative description, with reference to the drawings, of an embodiment of a pneumatic tire for aircraft, hereinafter referred to simply as “tire”, according to this disclosure.

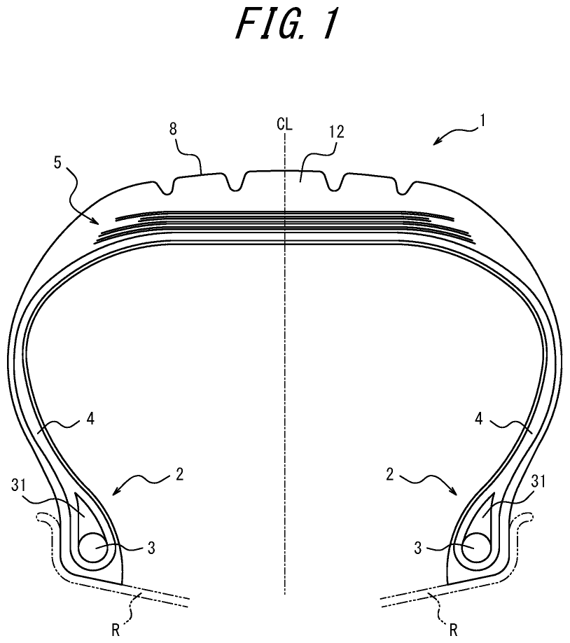

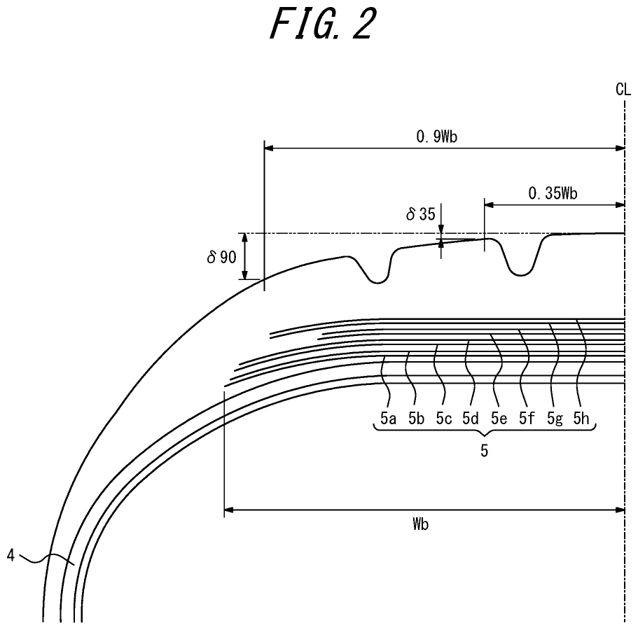

FIG. 1 illustrates a cross-sectional view in the tire width direction of a pneumatic tire for aircraft according to one embodiment of this disclosure. FIG. 2 illustrates an enlarged view of the main part of FIG. 1. FIGS. 1 and 2 illustrate the cross section in the tire width direction in the reference state, with the tire 1 mounted on the applicable rim R, filled to the prescribed internal pressure, and unloaded.

As illustrated in FIG. 1, the tire 1 comprises a pair of bead portions 2, a carcass 4 comprising one or more carcass plies spanning the pair of bead portions 2 in a toroidal shape, and a belt 5 comprising one or more belt layers disposed radially outwardly of the crown portion of the carcass 4. A tread portion 12 made of tread rubber is disposed on the outside of the tire radial direction of the belt, and a pair of sidewall portions are connected to the tread portion.

The bead core 3 is buried in each of the bead portions 2. In the illustrated example, the bead core 3 consists of an annular cable bead. In the illustration, the bead core 3 is circular in cross section. The bead wire can be, for example, high-carbon steel wire. In this example, the bead filler 31 is disposed on the outer side, in the tire radial direction, of each bead cores 3. The bead filler 31 has an abbreviated triangular cross section, tapering in the tire width direction from the inside to the outside of the tire radial direction, but the bead filler 31 can have a variety of cross sections. For example, one or more types of any known hard rubber can be used for the bead filler 31.

The carcass 4 consists of one or more, e.g., 4 to 7, carcass plies. In this example, the carcass 4 is a radial carcass.

The carcass 4 consists of one or more overlapping carcass plies, for example 4 to 7 carcass plies are overlapped, and their ends are rolled up and secured around the bead core 3 from the inside to the outside in the tire radial direction. In this embodiment of tire 1, seven layers of carcass plies made of nylon cords are stacked on top of each other.

As illustrated in FIGS. 1 and 2, in this example, the belt 5 consists of 8 belt layers 5a-5h. In this example, the belt 5 has six spiral belt layers 5a-5f and two zigzag belt layers 5g and 5h disposed outside the spiral belt layers in the tire radial direction. However, the number of belt layers is not limited to the above; for example, the number of spiral belt layers can be 1 to 8, and the number of zigzag belt layers can be 2 to 4. From the viewpoint of weight reduction, the total number of belt layers is preferably 10 or less. The belt structure is also not limited to those described above; for example, an inclined belt layer can also be used, in which the belt cords cross each other between layers, at an angle of inclination of, for example, 30 degrees to 60 degrees to the tire circumferential direction.

In the illustrated example, the width of the belt layers in the tire width direction is, in order from largest to smallest width, 5a, 5b, 5d, 5g=5h, 5e, and 5f. In the illustration, the belt layer 5a is the widest belt layer with the greatest width in the tire width direction. The distance in the tire width direction from the tire equatorial plane CL to the edge of the widest belt layer 5a is Wb. Note that, the width of the belt layers is not limited to the above examples, and any of the belt layers may have the maximum width in the tire width direction, and the relationship between the widths of the belt layers other than the widest belt layer in the tire width direction is not particularly limited.

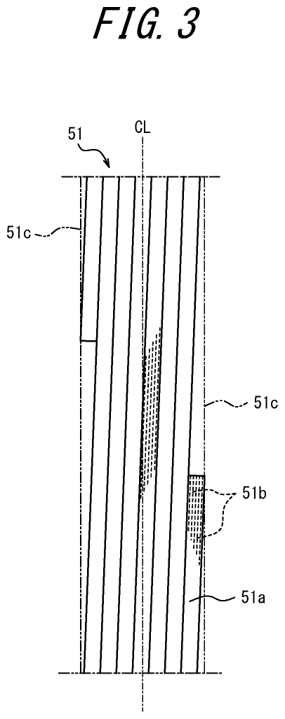

Here, the spiral belt layer is explained. FIG. 3 illustrates the spiral belt layer. As illustrated in FIG. 3, the spiral belt layer 51 consists of a ribbon-like first strip member 51a made with a first belt cord 51b coated with rubber, spirally wound in the circumferential direction of the tire.

As the first belt cord 51b, an organic fiber cord made of aromatic polyamide such as aramid can be used, alternatively, a hybrid fiber cord made from aliphatic polyamide such as nylon or the combinations of aromatic polyamide such as aramid and aliphatic polyamide such as nylon can be used.

The hybrid cord of aliphatic and aromatic polyamide fibers may be made by twisting yarns made of aliphatic polyamide fibers with yarns made of aromatic polyamide fibers, or made of pre-composited and twisted yarns of aliphatic and aromatic polyamide fibers.

The spiral belt layer 51 is formed by spirally winding the strip members 51a around the circumferential direction of the tire on the crown of the carcass 4 of the raw tire, with the strip members 51a deviating by a predetermined amount in the tire width direction so that no gap is created between adjacent strip members 51a. The inclination angle of the first belt cord 51b with respect to the circumferential direction of the tire is, for example, 5 degrees or less.

When the spiral belt layer 51 consists of multiple layers, the strip member 51a is folded back when it is wound up to the widthwise end edge 51c of the spiral belt layer 51 and begins to be wound around the outer surface as the next layer toward the other widthwise end edge 51c, thereby stacking them.

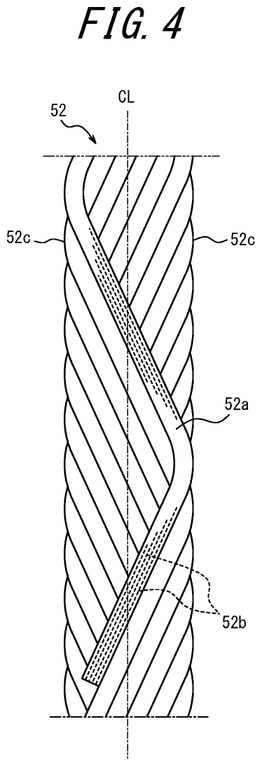

Next, the zigzag belt layer is explained. FIG. 4 illustrates the zigzag belt layer. The zigzag belt layer 52 consists of a ribbon-like second strip member 52a made with a second belt cord 52b coated with rubber, spirally wound in the circumferential direction of the tire so that the following manners are repeated: extending from one tire width direction end 52c to the other tire width direction end 52c, folded back at the other tire width direction end 52c, extending from the other tire width direction end 52c to the one tire width direction end 52c, folded back at the one tire width direction end 52c, and extending again from the one tire width direction end 52c to the other tire width direction end 52c.

As the second belt cord 52b, an organic fiber cord made of aromatic polyamide such as aramid can be used, alternatively, a hybrid fiber cord made from aliphatic polyamide such as nylon or the combinations of aromatic polyamide such as aramid and aliphatic polyamide such as nylon can be used.

The hybrid cord of aliphatic and aromatic polyamide fibers may be made by twisting yarns made of aliphatic polyamide fibers with yarns made of aromatic polyamide fibers, or made of pre-composited and twisted yarns of aliphatic and aromatic polyamide fibers.

Return to FIGS. 1 and 2, in the tire of this embodiment, in a reference state, Rc is the radius at the outer surface 8 of the tire at the tire equatorial plane CL, and Wb is the distance in the tire width direction from the tire equatorial plane CL to the edge of the widest belt layer 5a that has the greatest width in the tire width direction, the diameter difference, radius difference, between the outer surface 8 of the tire at the tire equatorial plane CL and the outer surface 8 of the tire at a position 35% of the distance Wb outward from the tire equatorial plane CL in the tire width direction is δ35, the diameter difference between the outer surface 8 of the tire at the tire equatorial plane CL and the outer surface 8 of the tire at a position 90% of the distance Wb outward from the tire equatorial plane CL in the tire width direction is δ90, and the following inequalities are satisfied:

0 ≤δ35/Rc≤0.004 and 0.015≤δ90/Rc≤0.025

The following is an explanation of the effects of this embodiment of pneumatic tire for aircraft.

According to the pneumatic tire for aircraft of this embodiment, first, by setting δ35/Rc≤0.004 (relatively small), the ground contact width at very low load immediately after the touchdown can be secured and the touchdown wear can be suppressed. Also, by setting δ90/Rc≤0.025 (relatively small), the drag due to the diameter difference at the shoulder portion of the tire during taxiing can be reduced, thus the taxi wear can also be suppressed. Furthermore, by setting δ90/Rc≥0.015, the belt tension at the shoulder portion can be increased to improve standing wave performance. In addition, by setting 0≤δ35/Rc, the tire can be grounded around the tire equatorial plane.

As described above, the pneumatic tire for aircraft according to this embodiment can suppress the wear that occurs when moving through airports, while also suppressing the wear that occurs at extremely low loads at the moment the aircraft lands, and it can also improve the standing wave performance.

For the same reasons as above, in the reference state,

it is more preferable to satisfy the following inequality:

0≤δ35/Rc≤0.002 and 0.018≤δ90/Rc≤0.023

Further, in the reference state,

it is preferable to further satisfy the following inequality:

0.014≤(δ90-δ35)/Rc≤0.024

By setting (δ90-δ35)/Rc≤0.024, the taxi wear can further be suppressed, while by setting 0.014≤(δ90-δ35)/Rc, the standing wave performance can be further improved.

For the same reasons, in the reference state,

it is further preferable to satisfy the following inequality:

0.016≤(δ90-δ35)/Rc≤0.022

Here, it is preferable that in one or more of the belt layers, the belt cords with an elastic modulus of 30 cN/dtex or greater extend at an angle of inclination of 10 degrees or less with respect to the tire equatorial plane. This is because the circumferential stiffness of the belt layer is increased to ensure that the tire shape is more reliably maintained when the prescribed internal pressure is filled, and each of the above effects can be obtained more reliably. For example, one or more of the belt layers can be the spiral belt layer described above. In this case, in order to achieve the above elastic modulus in the belt layer, it is preferable to use a hybrid cord of nylon and aramid, although not particularly limited.

For the same reason, in the above case, it is further preferred that the elastic modulus of the belt cord is 100 cN/dtex or greater. In this case, in order to achieve the above elastic modulus in the belt layer, it is preferable to use a aramid cord, although not particularly limited.

Here, it is preferable that the above distance Wb is 70 to 90% of the maximum tire width (the maximum width in the tire width direction of the tire in the above standard condition). By setting the minimum 70%, the standing wave can further be suppressed, while by setting the maximum 90%, the weight can be reduced.

### EXAMPLES

In order to confirm the effect of this disclosure, an example tire, and a comparative example tire, having a tire size of H44.5×16.5×R21 were manufactured as prototypes. The example and comparative example tires have a carcass consisting of five carcass plies made of nylon. The example and comparative example tires have a belt structure with six spiral belt layers and two zigzag belt layers, from the inner side in the tire radial direction. In the example and comparative example tires, the belt cords of the zigzag belt layer were nylon cords, and the belt cords of the spiral belt layer were aramid cords. In the example and comparative example tires, the distance Wb was 150 mm and Rc was 573 mm. For the comparative example tire, δ35/Rc=0.0080/, δ90/Rc=0.031, and (δ90-δ35)/Rc=0.023. For the example tire, δ35/Rc=0.0016, δ90/Rc=0.021, and (δ90-δ35)/Rc=0.020.

The following tests were conducted on the example and comparative example tires:

<Taxi Wear>

Predicted wear energy was calculated by the Finite Element Method and expressed as an index with the comparative example set at 100. The smaller the index, the slower the wear rate and the better the wear performance.

<Touchdown Wear Resistance Performance>

The touchdown phenomenon was simulated, and the amount of wear per touchdown at the tire equatorial plane was calculated and expressed as an index with the comparative example set at 100. The smaller the index, the better the wear performance.

<Standing Wave Performance>

A drum test was conducted to simulate tire inputs during takeoff. A video camera was used to capture the side portion of the tire and measure the speed at which the standing wave occurred. The index is expressed as an index with the comparative example set at 100. The larger the index, the greater the speed of standing wave generation and the better the standing wave performance.

The evaluation results for the example were as follows. Wear resistance performance during turning: 94, Touchdown wear resistance performance: 78, Standing wave performance: 100.

Reference Signs List

1 pneumatic tire for aircraft

2 bead portion

3 bead core

4 carcass

5 belt

8 outer surface of the tire

12 tread portion

R applicable rim

1. A pneumatic tire for aircraft comprising:
a pair of bead portions;
a carcass comprising one or more carcass plies spanning the pair of bead portions in a toroidal shape; and
a belt comprising one or more belt layers disposed radially outwardly of the crown portion of the carcass; wherein,
in a reference state, in which the pneumatic tire for aircraft is mounted on an applicable rim, filled to prescribed internal pressure, deflated to 50 kPa after that, and with no load,
Rc is the radius at the outer surface of the tire at the tire equatorial plane, and Wb is the distance in the tire width direction from the tire equatorial plane to the edge of the widest belt layer that has the greatest width in the tire width direction,
the diameter difference between the outer surface of the tire at the tire equatorial plane and the outer surface of the tire at a position 35% of the distance Wb outward from the tire equatorial plane in the tire width direction is δ35,
the diameter difference between the outer surface of the tire at the tire equatorial plane and the outer surface of the tire at a position 90% of the distance Wb outward from the tire equatorial plane in the tire width direction is δ90, and
the following inequalities are satisfied.
0≤δ35/Rc≤0.004 and 0.015≤δ90/Rc≤0.025

2. The pneumatic tire for aircraft according to claim 1, wherein in the reference state, the following inequality is further satisfied.
0.014≤(δ90-δ35)/Rc≤0.024

3. The pneumatic tire for aircraft according to claim 1, wherein in one or more of the belt layers, belt cords with an elastic modulus of 30 cN/dtex or greater extend at an angle of inclination of 10 degrees or less with respect to the tire equatorial plane.

4. The pneumatic tire for aircraft according to claim 3, wherein the elastic modulus of the belt cord is 100 cN/dtex or greater.

5. The pneumatic tire for aircraft according to claim 2, wherein in one or more of the belt layers, belt cords with an elastic modulus of 30 cN/dtex or greater extend at an angle of inclination of 10 degrees or less with respect to the tire equatorial plane.

6. The pneumatic tire for aircraft according to claim 5, wherein the elastic modulus of the belt cord is 100 cN/dtex or greater.
